(19) United States
(12) Patent Application Publication
(10) Pub. No.: US 2015/0074247 A1
(43) Pub. Date: Mar. 12, 2015

(54) APPARATUS AND METHOD FOR SETTING UP COMPUTTING ENVIRONMENTS

(71) Applicant: Electronics and Telecommunications Research Institute, Daejeon (KR)

(72) Inventors: Kyoung-Soon KANG, Daejeon (KR); Kyeong Ho LEE, Daejeon (KR); Byungjun AHN, Daejeon (KR); Ki Cheol JEON, Daejeon (KR); Hea Sook PARK, Daejeon (KR)

(73) Assignee: Electronics and Telecommunications Research Institute, Daejeon (KR)

(21) Appl. No.: 14/245,032

(22) Filed: Apr. 4, 2014

(30) Foreign Application Priority Data
Sep. 11, 2013 (KR) 10-2013-0108958

(51) Int. Cl. H04L 12/24

(52) U.S. Cl. CPC H04L 41/0803
USPC 709/220

(57) ABSTRACT

A method for setting up a computing environment, which includes: storing data for setting up computing environments necessary for the update of a plurality of client terminals that are connected through a network; receiving information about computing environments that are configured on the client terminals from the client terminals; upon receiving a request for the update from the client terminals, classifying the client terminals that share the same system image; and transferring the latest version of the data for setting up the computing environments which are higher than the client terminals of the client terminals; and updating the classified client terminals with the latest version of the data.

### RELATED APPLICATIONS

This application claims the benefit of Korean Patent Application No. 10-2013-0108958, filed on Sep. 11, 2013, which is hereby incorporated by reference as if fully set forth herein.

### FIELD OF THE INVENTION

The present invention relates to an apparatus and method for updating a number of client terminals that perform an identical operation, and, more particularly, to an apparatus and method for setting up a computing environment that shares the same system image wherein the same system image is downloaded to a plurality of client terminals to perform a dynamic update so as not only to automatically install an operating system and applications but also to perform an automatic configuration by specifying user settings that are configured on the client terminals at an initial hardware configuration to the respective the client terminals to be updated that share the same system image, thereby reducing maintenance costs.

### BACKGROUND OF THE INVENTION

In general, in order to build up a computing environment in which the same functions are carried out, the same operating system and the same applications have to be individually installed on a plurality of computing devices, and a separate setting such as IP address setup has to be independently carried out for each computing device.

In order to solve the aforementioned shortcomings, a method using a system image has been proposed in the art. Nonetheless, an individual setting for each computing device such as a client terminal or a server has also to be carried out although the system image is shared by all the client terminals.

Therefore, there is a need for a method for setting up a computing environment which automatically installs an operating system and some applications and also performs an automatic configuration by providing some relevant information that is configured on the client terminals at an initial hardware configuration phase to the client terminals that share the same system image.

### SUMMARY OF THE INVENTION

In view of the above, the present invention provides an apparatus and method for setting up a computing environment that shares the same system image wherein the same system image is downloaded to a plurality of client terminals to perform the dynamic update so as not only to automatically install an operating system and an application, but also to perform an automatic configuration by providing user settings that are configured on the client terminals at an initial hardware configuration to the client terminals to be updated that share the same system image, thereby reducing maintenance costs.

In accordance with an embodiment of the present invention, there is provided a method for setting up a computing environment, which includes: storing data for setting up computing environments necessary for the update of a plurality of client terminals that are connected through a network; receiving information about computing environments that are configured on the client terminals from the client terminals; upon receiving a request for the update from the client terminals, classifying the client terminals that share the same system image; and transferring the latest version of the data for setting up the computing environments which are higher than the client terminals of the client terminals; and updating the classified client terminals with the latest version of the data.

In the embodiment, wherein said transferring the latest version of the data for setting up the computing environments comprising: transferring the latest version of the data for setting up the computing environments which include user settings that are different from every client terminal.

In the embodiment, wherein the user settings are information configured on the client terminals at an initial hardware installation of the client terminals.

In accordance with an embodiment of the present invention, there is provided a method for setting up a computing environment, which includes: determining whether a client terminal needs to update information about its computing environment; when determining to update the information about computing environment, accessing a server for performing the update through a network to transmit a request for the update to the server; transferring information about a current computing environment of the client terminal to the server through the network; downloading the latest version of the data for setting up the computing environment which is higher than the computing environment of the client terminal from the server to the client terminal; and installing the downloaded data on the client terminal to update the computing environment of the client terminal.

In the embodiment, wherein said determining whether a client terminal needs to update comprising: analyzing update determination information that indicates whether to update an operating system of the client terminal in a user setting unit of the client terminal.

In the embodiment, wherein said transferring information about a current computing environment comprises: transferring the information about the current computing environment that includes a user setting of the client terminal.

In the embodiment, wherein the user setting includes information configured on the client terminal at an initial hardware installation of the client terminal.

In accordance with an embodiment of the present invention, there is provided an apparatus for setting up a computing environment, which includes: a communication unit configured to access a server on a network; a user setting unit configured to store update determination information to determine whether to update an operating system for the client terminal; an operating system module having the operating system for the client terminal and configured to refer the update determination information stored in the user setting unit and perform a request of the update when the update of the client terminal is necessary; and a boot loader configured to access the server, upon a receipt of the request for the update, to transfer information about a current computing environment of the client terminal to the server via the network, download data for setting up a computing environment higher than the computing environment of the client terminal from the server, and install the downloaded data on the client terminal to update the computing environment of the client terminal.

In the embodiment, wherein the boot loader is configured to include a user setting of the client terminal in the information about a computing environment of the client terminal so that the server can update one or more client terminals that share the same system image.

In the embodiment, wherein the user setting includes information configured on the client terminal at an initial hardware installation of the client terminal.

In the embodiment, wherein the boot loader is configured to boot up the client terminal with a new version of an operating system included in the data for setting up a computing environment.

In the embodiment, wherein the boot loader comprises a retry counter to count up when the client terminal does not boot up from the new version of the operating system, and the boot loader is further configured to boot up the client terminal with a previous version of the operating system when the count exceeds a predetermined threshold.

In the embodiment, wherein the boot loader is further configured to store an operating system, a configuration file and an application included in the data for setting up a computing environment to a memory of the client terminal.

In the embodiment, wherein the operating system module is configured to initialize the retry counter when the client terminal is successfully booted up from the new version of the operating system.

As set forth above, the embodiment of the present invention for setting up a computing environment that shares the same system image provides unique user settings that are different from every client terminal to the client terminals to be updated that share the same system image. Accordingly, the same system image is downloaded to a plurality of client terminals to perform the dynamic update so as not only to automatically install an operating system and an application, but also to perform an automatic configuration, thereby reducing maintenance costs.

### BRIEF DESCRIPTION OF THE DRAWINGS

The above and other objects and features of the present invention will become apparent from the following description of the embodiments given in conjunction with the accompanying drawings, in which:

FIG. 1 is a network configuration diagram of a system for setting up a computing environment that shares the same system image in accordance with an embodiment of the present invention; and

FIG. 2 is a detailed block diagram client terminal and a server in the system shown in FIG. 1 in accordance with an embodiment of the present invention.

### DETAILED DESCRIPTION OF THE EMBODIMENTS

Hereinafter, the embodiments of the present invention will be described in detail with reference to the accompanying drawings. In the following description, well-known functions or constitutions will not be described in detail if they would unnecessarily obscure the embodiments of the invention. Further, the terminologies to be described below are defined in consideration of functions in the invention and may vary depending on a user's or operator's intention or practice. Accordingly, the definition may be made on a basis of the content throughout the specification.

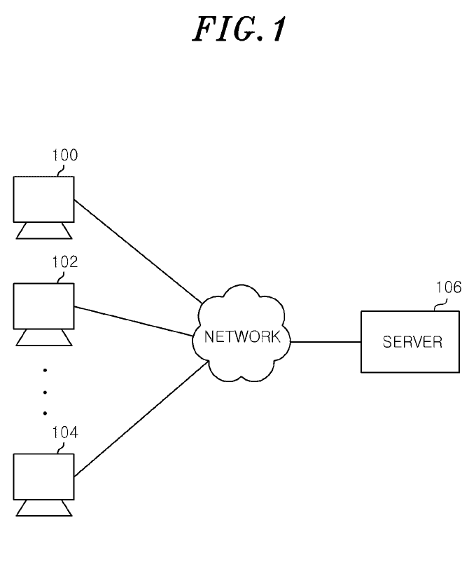

FIG. 1 is a network configuration diagram of a system for setting up a computing environment that shares the same system image in accordance with an embodiment of the present invention.

Referring to FIG. 1, a server 106 has a connection with a plurality of client terminals 100, 102, 104 through a network and downloads the same system image to one or more client terminals that share the same system image to update the client terminals all at once. The client terminals may be, for example, a personal computer (PC), a notebook computer, a tablet PC, or the like.

More specifically, the server 106 stores data for setting up computing environments necessary for updating the client terminals 100, 102, 104. Further, the server 106 receives and keeps information about current computing environments that are configured in the client terminals 100, 102, 104 from the client terminals. The server 106 specifies unique user settings that are configured on the client terminals at an initial hardware configuration to their corresponding client terminals that share the same system image.

Each of the client terminals 100, 102, 104 receives the data for setting the computing environment, which is downloaded from the server 106, including an operating system (OS), a user setting, and the like to update themselves automatically in accordance with the data.

More specifically, when the client terminal needs the update, the client terminal 100, 102, 104 accesses the server 106 on the network, sends a request for the update to the server 106, and transfers the information about its current computing environment that is configured on the client terminals at an initial hardware configuration to the server 106.

Further, each of the client terminal 100, 102, 104 downloads the latest version of the data for setting up the computing environment which is higher than that of the client terminal from the server 106 and installs the latest version of the data to update its computing environment.

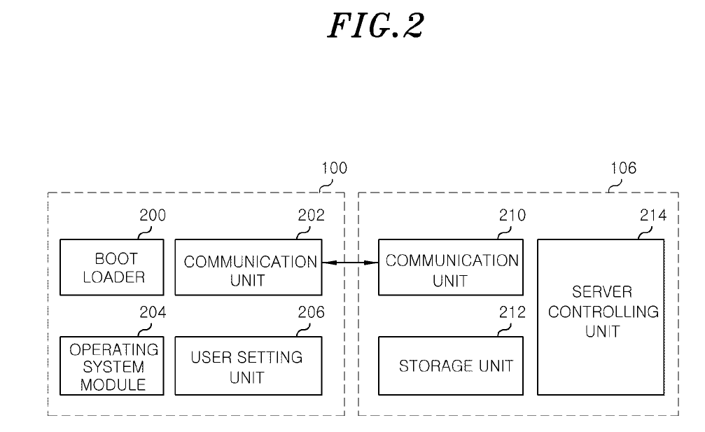

FIG. 2 is a detailed block diagram of each client terminal, e.g., the client terminal 100 and the server 106 in the system shown in FIG. 1 in accordance with an embodiment of the present invention.

Hereinafter, the operation of the respective components of the client terminal 100 and the server 106 will be described with reference to FIG. 2.

First, the server 106 includes a storage unit 212, a communication unit 210, and a server controlling unit 214.

The storage unit 212 serves to store a system image and a version file necessary for cooperation with the client terminal 100. The system image includes an operating system, a configuration file, and an application. The version file keeps always the latest version of the operating system and the application.

The communication unit 210 is used to communicate with the client terminal 100 and specifically to transfer messages to the client terminal 100 and to download data to the client terminal 100. The communication unit 210 is also used to reset a specific client terminal in cooperation with the RESET signal of the client terminal 100. For example, the communication unit may be implemented by a network interface card.

The server controlling unit 214 provides a unique user setting which is specific to one or more client terminal 100 that share the same system image so that the same system image can be downloaded to and installed on the client terminals 100.

The client terminal 100 includes a boot loader 200, an operating system module 204, a user setting unit 206, and a communication unit 202 for communicating with the server 106.

The boot loader 200 includes a message function, a download function, a storage function, and retry counter.

The message function of the boot loader 200 exchanges with the server 106 information which includes a hardware type, an operating system version, a configuration file version, an application version. When the client terminal 100 cannot communicate with the server 106, the client terminal is booted up from an operating system and a configuration file that has been previously stored in the client terminal. The download function of the boot loader 200 is responsible for downloading the operating system, the configuration file and the application from the server 106 to the client terminal 100. The storage function of the client terminal 100 stores the operating system, the configuration file and application that are downloaded from the server 106 in a non-volatile memory.

The retry counter of the boot loader 200 counts when the client terminal cannot boot up with the operating system. If a count of the retry counter exceeds a predetermined threshold value, the boot loader 200 boots up the client terminal with a previous version of the operating system that has been stored in the client terminal. When any previous version of the operating system is not present in the client terminal, the boot loader downloads again an operating system from the server 106.

The operating system module 204 of the client terminal 100 executes a dynamic update function and an initialization of the retry counter. The dynamic update function is used for downloading and storing the configuration file and the application and for keeping the latest version of the system of the client terminal by utilizing the configuration file and the application. Whether to use the dynamic update function is determined by a value of Dynamic Update, e.g., “TRUE” or “FALSE”, of the user settings.

Once the client terminal normally boots up, the operating system module 204 initializes the count of the retry counter of the boot loader 200 to zero (0) to notify that the operating system has been loaded normally. As an example, a value of Dynamic Update among the user settings of the client terminal 100 is set to “TRUE”, the value is initialized to zero after the dynamic update is performed by the operating system unit 204.

This makes the boot loader 200 acknowledge that the operating system has been operating normally by reading the updated value of the retry counter at a next boot time.

The user setting unit 206 is used to determine a hardware type, an ID, and whether to perform the dynamic update. The hardware type is a value stored in a non-volatile memory or a value configured by jumper setting and is used to designate a hardware device which has the same function as other hardware devices but is configured to carry out a separate work.

The ID may be a value of a shelf number or a slot number with which the client terminal 100 is mounted, and the value is stored in a non-volatile memory or configured by jumper setting. The value of the ID enables the boot loader 200 to identify its corresponding client terminal among the client terminals having an identical hardware architecture, so that an automatic setting of IP address can be achieved in association with the configuration file after booting up the operating system.

A value as to whether to perform the dynamic update is stored in a non-volatile memory or is configured by jumper setting. When this value is TRUE, the dynamic update is carried out after being booted up with the operating system, thereby maintain the latest update for the client terminal. Meanwhile, when the value is FALSE, the application will be kept without the update.

As described above, in a computing environment that shares the same system image, unique user settings that are different from every client terminal are provided to the client terminals to be updated that share the same system image. Accordingly, the same system image is downloaded to the client terminals to perform the dynamic update so as not only to automatically install an operating system and an application, but also to perform an automatic configuration, thereby reducing maintenance costs.

While the description of the present invention has been made to the exemplary embodiments, various changes and modifications may be made without departing from the scope of the invention. The embodiment of the present invention is not limited thereto. Therefore, the scope of the present invention should be defined by the appended claims rather than by the foregoing embodiments.

What is claimed is:

1. A method for setting up a computing environment, the method comprising:
storing data for setting up computing environments necessary for the update of a plurality of client terminals that are connected through a network;
receiving information about computing environments that are configured on the client terminals from the client terminals;
upon receiving a request for the update from the client terminals, classifying the client terminals that share the same system image; and
transferring the latest version of the data for setting up the computing environments which are higher than the client terminals of the client terminals; and
updating the classified client terminals with the latest version of the data.

2. The method of claim 1, wherein said transferring the latest version of the data for setting up the computing environments comprising:
transferring the latest version of the data for setting up the computing environments which include user settings that are different from every client terminal.

3. The method of claim 2, wherein the user settings are information configured on the client terminals at an initial hardware installation of the client terminals.

4. A method for setting up a computing environment, the method comprising:
determining whether a client terminal needs to update information about its computing environment;
when determining to update the information about computing environment, accessing a server for performing the update through a network to transmit a request for the update to the server;
transferring information about a current computing environment of the client terminal to the server through the network;
downloading the latest version of the data for setting up the computing environment which is higher than the computing environment of the client terminal from the server to the client terminal; and
installing the downloaded data on the client terminal to update the computing environment of the client terminal.

5. The method of claim 4, wherein said determining whether a client terminal needs to update comprising:
analyzing update determination information that indicates whether to update an operating system of the client terminal in a user setting unit of the client terminal.

6. The method of claim 4, wherein said transferring information about a current computing environment comprises:
transferring the information about the current computing environment that includes a user setting of the client terminal.

7. The method of claim 6, wherein the user setting includes information configured on the client terminal at an initial hardware installation of the client terminal.

8. An apparatus for setting up a computing environment, the apparatus comprising:
a communication unit configured to access a server on a network;
a user setting unit configured to store update determination information to determine whether to update an operating system for the client terminal;
an operating system module having the operating system for the client terminal and configured to refer the update determination information stored in the user setting unit and perform a request of the update when the update of the client terminal is necessary; and
a boot loader configured to access the server, upon a receipt of the request for the update, to transfer information about a current computing environment of the client terminal to the server via the network, download data for setting up a computing environment higher than the computing environment of the client terminal from the server, and install the downloaded data on the client terminal to update the computing environment of the client terminal.

9. The method of claim 8, wherein the boot loader is configured to include a user setting of the client terminal in the information about a computing environment of the client terminal so that the server can update one or more client terminals that share the same system image.

10. The method of claim 9, wherein the user setting includes information configured on the client terminal at an initial hardware installation of the client terminal.

11. The method of claim 8, wherein the boot loader is configured to boot up the client terminal with a new version of an operating system included in the data for setting up a computing environment.

12. The method of claim 11, wherein the boot loader comprises a retry counter to count up when the client terminal does not boot up from the new version of the operating system, and
the boot loader is further configured to boot up the client terminal with a previous version of the operating system when the count exceeds a predetermined threshold.

13. The method of claim 8, wherein the boot loader is further configured to store an operating system, a configuration file and an application included in the data for setting up a computing environment to a memory of the client terminal.

14. The method of claim 12, wherein the operating system module is configured to initialize the retry counter when the client terminal is successfully booted up from the new version of the operating system.
